(19) United States
(12) Patent Application Publication
(10) Pub. No.: US 2007/0207637 A1
(43) Pub. Date: Sep. 6, 2007

(54) COMPOSITE CIRCUIT BOARD

(75) Inventors: Satoshi Ito, Kariya-shi (JP); Kazuhiro Maeno, Kariya-shi (JP); Takamasa Nodo, Kariya-shi (JP)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Kabushiki Kaisha Toyota Jidoshokki, Kariya-shi (JP)

(21) Appl. No.: 11/679,698

(22) Filed: Feb. 27, 2007

(30) Foreign Application Priority Data
Feb. 28, 2006 (JP) 2006-053230

(51) Int. Cl. H01R 12/00

(52) U.S. Cl. 439/74

(57) ABSTRACT

A composite circuit board includes a first circuit board having a first land and a second circuit board having a second land at least a part of which is soldered to a part of the first land face-to-face. The first land has a region overlapped by the second circuit board. The region has a non-facing region which does not face to the second land.

### BACKGROUND OF THE INVENTION

The present invention relates to a composite circuit board wherein circuit boards are overlapped and connected, specifically to a composite circuit board wherein lands on a pair of circuit boards are connected face-to-face by soldering.

In the printed wiring board disclosed in Japanese Patent Application Publication No. 2005-302824, as illustrated in FIGS. 11A, 11B and 11C, a first printed wiring board 111 and a second printed wiring board 112 have the same structure. The printed wiring board includes first pad groups 111a, 112a and second pad groups 111b, 112b that are formed on the front sides of the printed wiring board with respect to the first pad groups 111a, 112a. The first printed wiring board 111 and the second printed wiring board 112 are soldered in a manner that the first pad group 111a faces to the second pad group 112b and the second pad group 111b faces to the first pad group 112a. Here, the first pad group 111a is formed even in the ends of the wirings being led out where the first printed wiring board 111 is not covered and concealed by the second printed wiring board 112, as illustrated as an area surrounded by a dashed line in the drawing. In the same manner, on the backside, the first pad group 112a is formed even in the ends of the wirings being led out where the second printed wiring board 112 is not covered and concealed by the first printed wiring board 111.

In Japanese Patent Application Publication No. 2005-302824, the ends of the first pad groups 111a, 112a are not covered and concealed; therefore, it is possible to confirm the quality of solder bonding by viewing the solder fillets that are formed in the ends of the first pad groups 111a, 112a. The solder fillets also serve to enhance the strength of solder bonding in the direction of the wire leads.

However, the solder fillets are formed only in the direction of the wire leads; therefore, there is a real danger that the strength of solder bonding in different directions from the direction parallel to the wire leads is not sufficiently secured.

The present invention is directed to a composite circuit board that makes it possible to easily view and confirm the quality of solder bonding and to secure a sufficient strength of solder bonding, in soldering a pair of circuit boards with mutually overlapped areas.

### SUMMARY OF THE INVENTION

In accordance with an aspect of the present invention, a composite circuit board includes a first circuit board having a first land and a second circuit board having a second land at least a part of which is soldered to a part of the first land face-to-face. The first land has a region overlapped by the second circuit board. The region has a non-facing region which does not face to the second land.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a plan view illustrating a first circuit board according to a first embodiment of the present invention;

FIG. 2 is a plan view illustrating a portion of a second circuit board according to the first embodiment of the present invention;

FIG. 3 is a plan view illustrating a composite circuit board according to the first embodiment of the present invention, wherein the first circuit board and the second circuit board are soldered;

FIG. 4 is a plan view illustrating an overlap of a first land of the first circuit board and a second land of the second circuit board in the composite circuit board according to the first embodiment of the present invention;

FIG. 5 is a sectional view illustrating the state of the solder bonding in the section (X)-(X′) in FIG. 4;

FIG. 6 is a sectional view illustrating the state of the solder bonding in the section (Y)-(Y′) in FIG. 4;

FIG. 7 is a plan view illustrating an overlap of first lands of the first circuit board and second lands of the second circuit board in a composite circuit board according to a modified example of the first embodiment of the present invention;

FIG. 8 is a plan view illustrating an overlap of first lands of the first circuit board and second lands of the second circuit board in a composite circuit board according to a second embodiment of the present invention;

FIGS. 9A and 9B are plan views illustrating a second land according to a third embodiment of the present invention;

FIG. 10 is a sectional view illustrating the state of the solder bonding in a composite circuit board according to the third embodiment of the present invention; and

FIGS. 11A, 11B and 11C are plan views illustrating a prior art printed wiring board.

### DETAILED DESCRIPTION OF THE PREFERRED EMBODIMENTS

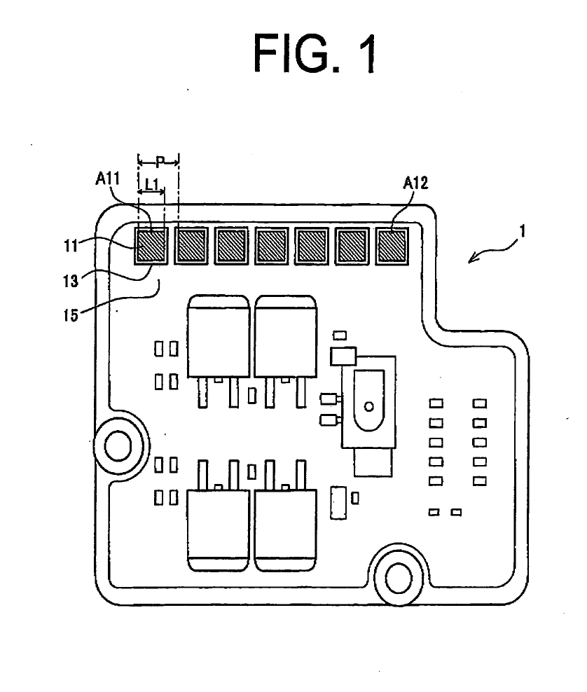

The following will describe embodiments of a composite circuit board according to the present invention in detail with reference to FIG. 1 through FIG. 10.

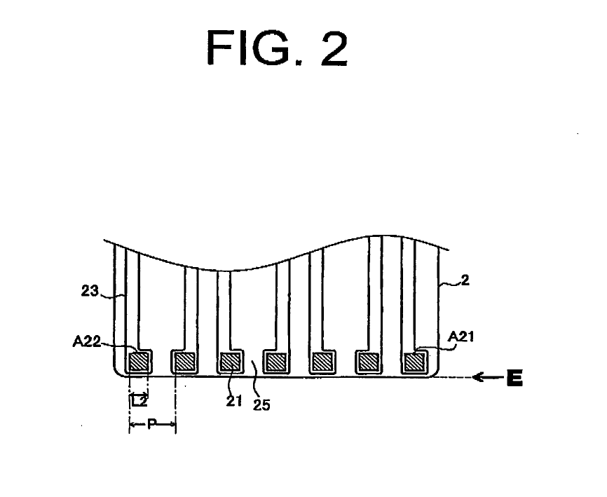

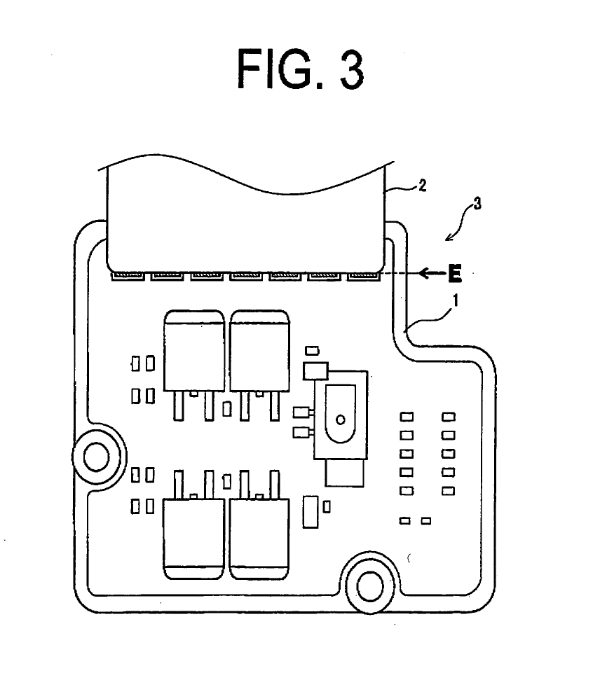

A composite circuit board 3 relating to the first embodiment of the present invention illustrated in FIG. 3 is formed such that a first circuit board 1 illustrated in FIG. 1 and a second circuit board 2 illustrated in FIG. 2 are connected with an overlap. There are various circuit components mounted on the first circuit board 1, namely, passive elements such as capacitors and resistors and so forth, and active elements such as diodes and transistors and so forth. These circuit components are mounted on the first circuit board 1 by various methods such as soldering, crimping, screwing, and so forth. In case of the solder bonding, the bonding method that solders components on a board surface by means of the surface mount technology is frequently used in recent years to meet the demand for the high-density mounting, along with the bonding method that inserts the lead terminals of circuit components into holes of a circuit board and fills solder into the holes.

The second circuit board 2 is supposed to be a printed wiring board and the like wherein wiring patterns are formed to connect the first circuit board 1 and a circuit board (not illustrated) and other devices, in addition to a circuit board on which circuit components are mounted in the same manner as the first circuit board 1. Here, the printed wiring board wherein wiring patterns are formed includes an FPC (Flexible Printed Circuit) board, for example. In the following description, the first circuit board 1 and the second circuit board 2 are soldered by means of the surface mount technology.

When the first circuit board 1 and the second circuit board 2 are bonded by means of the surface mount technology, the metallic parts of both the circuit boards which have excellent solder wettability are bonded using solder. The metallic parts here are called lands. The first circuit board 1 is provided with first lands 11, and the second circuit board 2 is provided with second lands 21. The first and second lands 11, 21 are formed to be directly coupled to the metal wirings formed on the first and second circuit boards 1, 2. In general, the circuit board has a protective film coated with an insulating material for protecting metal wirings after mounted, which is formed on the surface thereof. The first and second lands 11, 21 are formed in a manner that protective films 15, 25 (illustrated in FIGS. 5, 6 and 10 as described in detail later) are removed and metal wirings are exposed.

In the circuit board 1 illustrated in FIG. 1, for example, the protective films 15 formed on metal wirings 13 are removed in part, and the first lands 11 each are formed in a square with one side length L1. The first lands 11 are disposed in a row with a pitch P. That is, any two adjacent first lands 11 are disposed at an equal distance P. In the circuit board 2 illustrated in FIG. 2, the protective films 25 are removed in part on the ends of metal wirings 23, and the second lands 21 each are formed in a square with one side length L2. The second lands 21 are disposed in a row with the pitch P. That is, any two adjacent second lands 21 are disposed at an equal distance P. Here, the one side length L1 is assumed to be longer than the one side length L2 (L1>L2).

The wiring patterns of the metal wiring 13 are not illustrated as to the first circuit board 1. There can be a case that the wiring patterns of the first circuit board 1 are formed directly under the protective films 15 on the surface of the board, or they are formed on the backside and/or the inner layer in case of a multi-layered circuit board.

In the composite circuit board 3, seven wirings are coupled between the first circuit board 1 and the second circuit board 2. In order to couple these wirings by the solder bonding of the first circuit board 1 and the second circuit board 2, the first lands 11 and the second lands 21 are provided to each of the wirings. Both the first lands 11 and the second lands 21 are disposed in a row with the same pitch P.

In the solder bonding of the first circuit board 1 and the second circuit board 2, the alignment of the boards is made by means of an alignment mark not illustrated, and the like. The alignment is made, for example, at both the ends of the first and second lands 11, 21 disposed in a row. In the solder bonding of the first circuit board 1 and the second circuit board 2, it is necessary to set the first lands 11 and the second lands 21 face-to-face. A middle point A11 on the outermost side of the first land 11 disposed at one end thereof is aligned with a middle point A21 on the innermost side of the second land 21 disposed at the other end thereof. Further, a middle point A12 on the outermost side of the first land 11 disposed at the other end thereof is aligned with a middle point A22 on the innermost side of the second land 21 disposed at one end thereof. Thus, the outermost sides of the first lands 11 coincide with the innermost sides of the second lands 21, the middle points on the sides each coincide, and the first lands 11 will necessarily face to the second lands 21.

Here, in the one side lengths L1, L2 of the first and second lands 11, 21, L1 is longer than L2 (L1>L2). The distance E1 from the outermost side of the second land 21 of the second circuit board 2 to the edge E of the second circuit board 2 is assumed to be shorter than L1−L2. In case of the composite circuit board 3 wherein the outermost side of the first land 11 and the innermost side of the second land 21 are put into coincidence, the inner ends of the first lands 11 protrude over the edge E of the second circuit board 2 being overlapped. The length of the protrusion is L1−L2−E1. Thus, parts of the first lands 11 can be directly viewed.

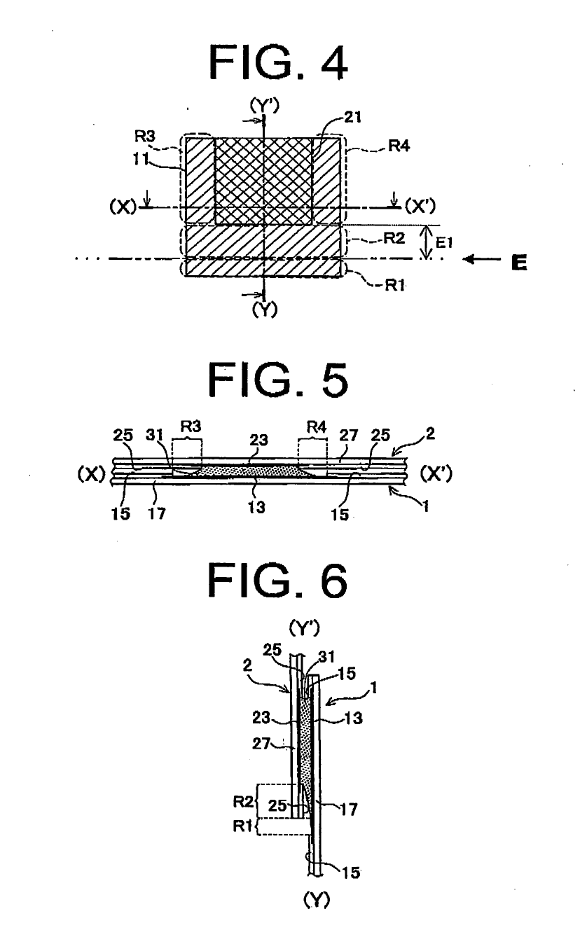

FIG. 4 illustrates the state where the first lands 11 and the second lands 21 are set face-to-face in the composite circuit board 3. In the drawing, the (Y′) side is the outer-end side of the first circuit board 1 in the composite circuit board 3, and the second circuit board 2 is laid out toward the (Y′) side from the edge E. FIG. 4 illustrates the state where the first lands 11 and the second lands 21 are set face-to-face in the condition that the first circuit board 1 and the second circuit board 2 are overlapped.

The first lands 11 and the second lands 21 are set face-to-face in the state where the end sides on the (Y′) side coincide with each other and the middle points on the (Y′) side coincide with each other. Since the one side length L1 of the first lands 11 is longer than the one side length L2 of the second lands 21, there exist non-facing regions R1 through R4 on the (Y), (X), and (X′) sides, wherein parts of the first lands 11 do not face the second lands 21.

The non-facing regions R1 and R2 exist on the (Y) side. The non-facing region R1 extends outside over the edge E of the second circuit board 2. The non-facing region R1 is a region where the second circuit board 2 does not overlap the first circuit board 1 in the composite circuit board 3. The width W1 of the non-facing region R1 that extends from the (Y′) side to the (Y) side is equal to L1−L2−E1. The non-facing region R2 exists from the edge E of the second circuit board 2 to the (Y′) side. The non-facing region R2 is a region where the second circuit board 2 overlaps the first circuit board 1 in the composite circuit board 3. The width W2 of the non-facing region R2 that extends from the (Y′) side to the (Y) side is E1.

Non-facing regions R3 and R4 exist on the (X) side and (X′) side, respectively. Since the first lands 11 and the second lands 21 are overlapped so as to bring the middle points of the sides into coincidence, the non-facing regions R3 and R4 are related by bilateral symmetry. Both the non-facing regions R3 and R4 have overlaps with the second circuit board 2. Both the widths W3, W4 of the non-facing regions R3 and R4 that extend in the direction (X)-(X′) are equal to (L1−L2)/2.

When the first lands 11 and the second lands 21 are soldered, since the solder wettability of each of the lands is satisfactory, melted solder spreads with a gentle slope from the regions where the first lands 11 and the second lands 21 face each other toward the non-facing regions R1 through R4. Thus, solder fillets are formed in the three directions of the (X), (X′), and (Y) sides, In continuance to the solder bonding that bonds the facing sides of the first and second lands 11, 21. The solder fillets serve to enhance the strength of solder bonding against stresses in the directions (X)-(X′) and (Y)-(Y′).

The non-facing region R1 is a part of the non-facing regions R1 through R4, which does not overlap with the second circuit board 2. Therefore, it is possible in this non-facing region R1 to directly view the state of the solder fillets. It is possible to easily confirm the state of the solder bonding of the first and second lands 11, 21. Particularly, the non-facing region R1 is the farthest region from the facing sides of the first and second lands 11, 21 among the non-facing regions R1 through R4. Therefore, it is possible to confirm the state of the solder fillets at the farthest non-facing region R1. Thus, the state of the solder bonding can be confirmed more reliably.

FIG. 5 and FIG. 6 are the sectional views Illustrating the state of the solder bonding of the first and second lands 11, 21. FIG. 5 illustrates the section (X)-(X′) in FIG. 4, and FIG. 6 illustrates the section (Y)-(Y′) in FIG. 4.

In the first and second circuit boards 1 and 2, wirings are formed on bases 17, 27 by metal wirings 13, 23, and the protective films 15, 25 are coated on the wirings; the protective films are removed from the first and second lands 11, 21 and the metal wirings 13, 23 are exposed. The metal wirings 13, 23 are bonded through a solder 31 in the first and second lands 11, 21 where the metal wirings 13, 23 are exposed. The solder 31 does not only remain in the facing region, but it spreads to the non-facing regions R1 through R4 of the first lands 11. Since there is not any facing metal wiring in the non-facing regions R1 through R4, the soldering forms a gently sloped solder fillet. In regard to the direction (X)-(X′), the solder fillets are formed in bilateral symmetry in the non-facing regions R3, R4, as illustrated in FIG. 5.

In regard to the direction (Y)-(Y′), the solder fillets are formed across the non-facing regions R1, R2, as illustrated in FIG. 6. Of the two regions, the non-facing region R1 does not overlap with the second circuit board 2; therefore, the solder fillets can be confirmed.

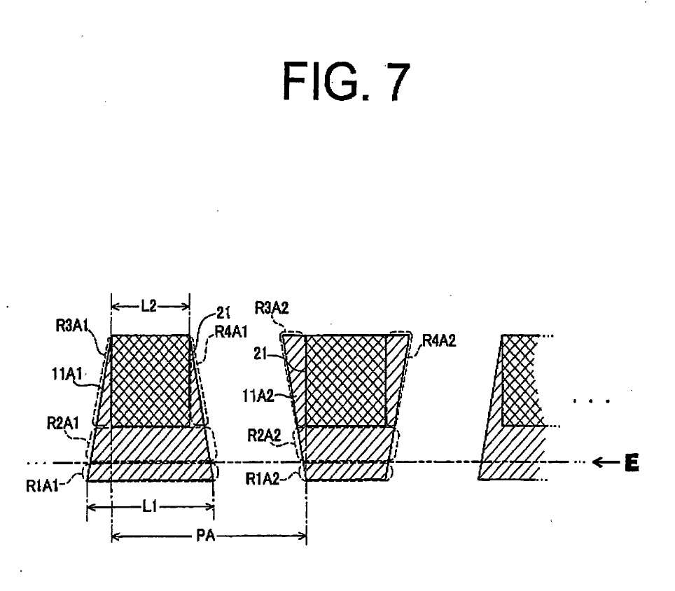

FIG. 7 illustrates a modified example of the first embodiment, wherein the second lands 21 are the same as those of the first embodiment. In the first circuit board 1, first lands 11A1, 11A2 in a trapezoid shape are provided as a replacement for the first lands 11 in a square shape. Here, the first lands 11A1 each have a lower base having the same length as the one side length L1 of the first lands 11 and an upper base having the same length as the one side length L2 of the second lands 21. In the first circuit board 1, the first lands 11A1, 11A2 are laid out in a manner that the lower base and the upper base are alternately inverted at each of the lands placed adjacently.

Non-facing regions R1A1 through R4A1, R1A2 through R4A2 extend in three directions from the side for the alignment of the first lands 11A1, 11A2 and the second lands 21, in the same manner as the non-facing regions R1 through R4 (FIG. 4) of the first lands 11. The non-facing regions R1A1, R1A2 extend outside over the edge E of the second circuit board 2, in the same manner as the non-facing region R1. The non-facing regions R1A1, R1A2 both are regions where the second circuit board 2 does not overlap the first circuit board 1 in the composite circuit board 3. The non-facing regions R2A1, R2A2 exist on the side of the second circuit board 2 from the edge E. The non-facing regions R2A1, R2A2 are regions where the second circuit board 2 overlaps the first circuit board 1 in the composite circuit board 3. The non-facing regions R3A1, R3A2 and R4A1. R4A2 exist on both sides of the facing region in bilateral symmetry. The non-facing regions R3A1, R3A2 and R4A1, R4A2 are regions where the second circuit board 2 overlaps the first circuit board 1 in the composite circuit board 3.

The shapes of the non-facing regions R1A1 through R4A1, R1A2 through R4A2 are such that each of them fits to the trapezoid of the first lands 11A1, 11A2. The non-facing regions R1A1, R2A1 have a trapezoid shape where the widths thereof widen toward the lower base (one side length L1) of the first lands 11A1. The non-facing regions R3A1, R4A1 have a triangle shape where the widths thereof widen toward the lower base (one side length L1) of the first lands 11A1. The non-facing regions R1A2, R2A2 have a trapezoid shape where the widths thereof narrow toward the upper base (one side length L2) of the first lands 11A2. The non-facing regions R3A2, R4A2 have a triangle shape where the widths thereof narrow toward the upper base (one side length L2) of the first lands 11A2.

According to the modified example (FIG. 7) wherein the first lands 11A1 in a trapezoid shape having the lower base of the one side length L1 are adjacently disposed to be alternately inverted, the solder fillets are formed in the wiring direction and width direction of the first circuit board 1; therefore, the modified example exhibits the function and effect of the first embodiment (FIG. 4) that enhances the strength of solder bonding and facilitates determining the quality of solder bonding since part of the solder fillets can easily be viewed. In addition, by adjacently disposing the first lands 11A1, 11A2 in a trapezoid shape to alternately invert the upper base and the lower base, the pitch of disposition PA can be narrowed in comparison to the pitch of disposition P when the first lands 11 in a square shape are disposed. The reduced length per one pitch is P−PA, which is equal to (L1−L2)/2.

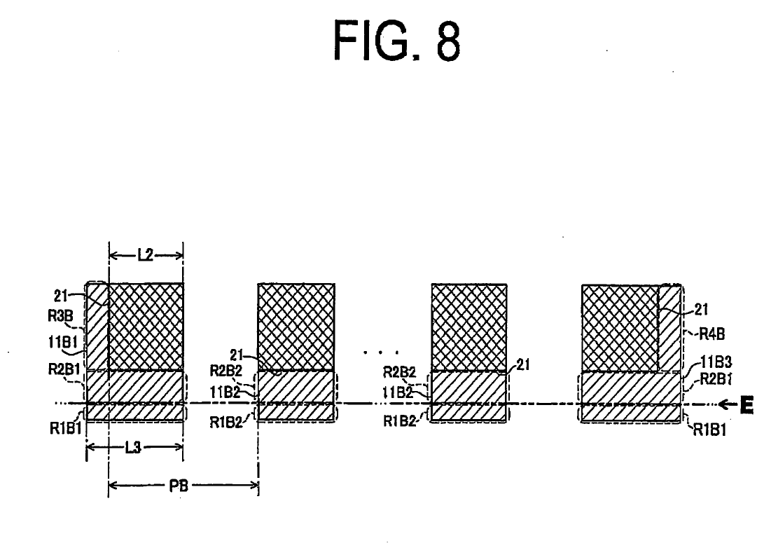

FIG. 8 illustrates the second embodiment, wherein the second lands 21 are the same as those of the first embodiment. In the first circuit board 1 wherein the first lands are disposed in one row to make up a first land row, the non-facing regions are not provided to the sides to which the first lands are adjoined. In particular, first lands 11B1, 11B3 placed on both the ends of the first land row are not provided with the non-facing regions on the inner sides thereof. The width in the row direction of the first lands 11B1 and 11B3 is one side length L3. Here, L3 is equal to L1−(L1−L2)/2. The first lands 11B2 located in the middle position of the first land row are not provided with the non-facing regions on the ends of both the sides to which the first lands 11B2 adjoin. The width in the row direction of the first lands 11B2 is the one side length L2, the same as that of the second lands 21. It is noted that the first land row serves as a region in which the first lands are disposed.

Thus, the non-facing regions R1B1, R2B1. R1B2, and R2B2 with the edge E of the second circuit board 2 placed in-between are provided to each of the first lands 11B1, 11B2, and 11B3, in the same manner as the first embodiment. In comparison to this, non-facing regions R3B and R4B are disposed on both the ends of the first land row. The first land 11B1 is on one end and is provided with the non-facing region R3B to face outward. The first land 11B3 is on the other end and is provided with the non-facing region R4B to face outward.

In regard to the wiring direction of the second circuit board 2, the solder fillets are formed, in the same manner as the first embodiment, on the non-facing regions R1B1, R2B1, R1B2, and R2B2 at each of the first lands 11B1 through 11B3. Thus, the strength of solder bonding is enhanced. Further, the solder fillets on the non-facing regions R1B1 and R1B2 can easily be viewed, and the quality of the solder bonding can easily be determined.

In regard to the width direction of the second circuit board 2, the solder fillets are not formed at each of the first lands 11B1 through 11B3; however, the solder fillets are formed on the non-facing regions R3B and R4B existing on both the ends of the first land row, whereby the strength of solder bonding in the width direction can be secured sufficiently.

In the second embodiment, since the non-facing regions are not provided between the first lands placed adjacently, the pitch of disposition PB of the first land can be reduced in comparison to the pitch P of the first embodiment and the pitch PA of the modified example. The reduced length per one pitch against the first embodiment is P−PB, being equal to L1−L2; and that against the modified example is PA−PB, being equal to (L1−L2)/2.

Thus, in the same manner as the first embodiment, the solder fillets are formed in the wiring direction and width direction of the second circuit board 2, which enhances the strength of solder bonding. Besides, the pitch of disposition PB of the first lands 11B1 through 11B3 and the second land 21 can further be reduced, in comparison to the first embodiment and the modified example.

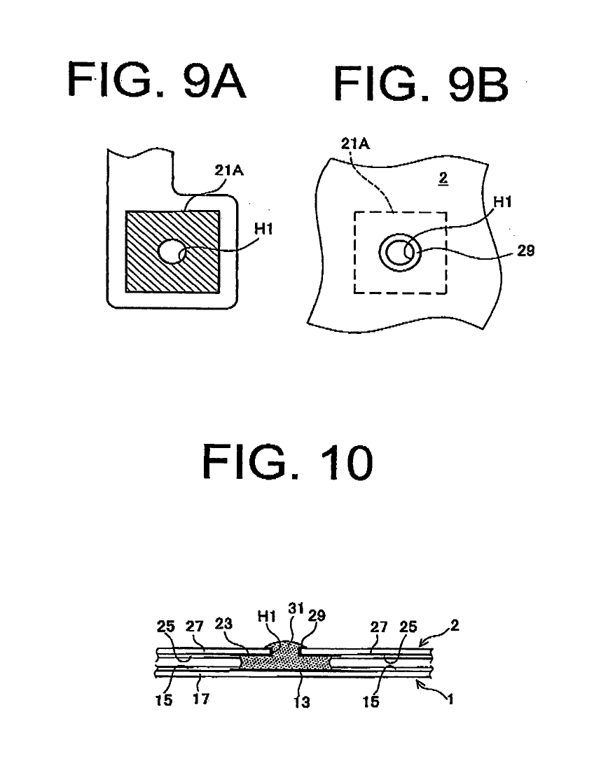

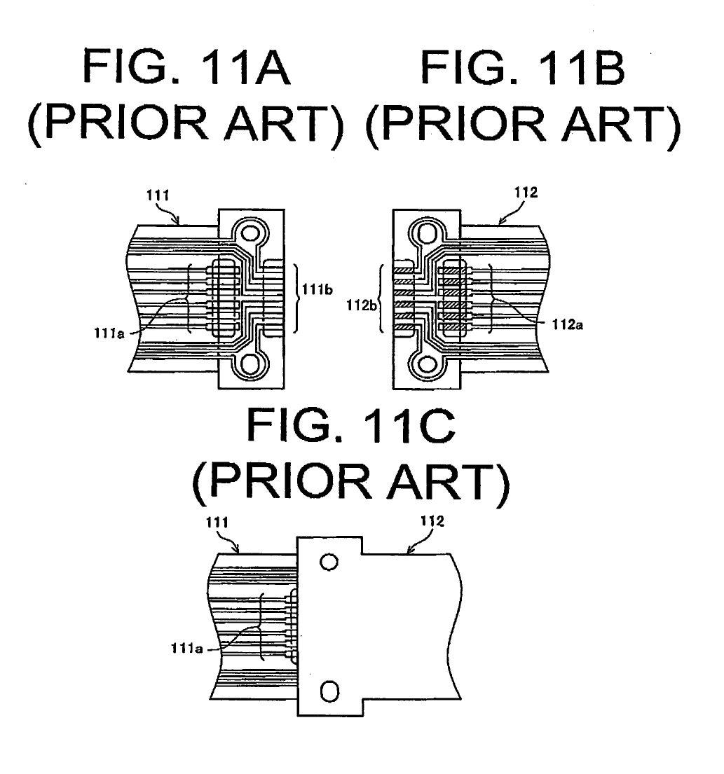

FIGS. 9A and 9B illustrate the third embodiment, in which FIG. 9A Illustrates a second land 21A of the second circuit board 2, and FIG. 9B illustrates a backside of the second land 21A. The second land 21A is provided with a through hole H1 that pierces the second circuit board 2. The through hole H1 is provided with a metal member having excellent solder wettablity on the side wall thereof and on a periphery 29 thereof on the backside.

FIG. 10 illustrates a section wherein the second land 21A is soldered to the first land face-to-face. Here, the one side length of the first land is assumed to be the same as that of the second land 21A.

As the first and second lands are soldered face-to-face, a solder 31 fills between the facing lands and inside the through hole H1 of the second land 21A as well. Further, the solder 31 reaches the periphery 29 of the hole on the backside. Since the side wall of the through hole H1 and the periphery 29 of the hole on the backside are made up with the metal member having excellent solder wettability, the filled solder 31 solders to the first and second lands as well as to the side wall of the through hole H1 and the periphery 29 of the hole on the backside.

Since the solder bonding is made between the first and second lands and on the side wall of the through hole H1, the strength of solder bonding can be secured in every direction of the side wall of the through hole H1. At the same time, the through hole H1 is a hole that pierces the second circuit board 2, and this area serves as a non-facing region. The through hole H1 facilitates viewing the state of the solder bonding.

According to the embodiments thus described, in the solder bonding of the first and second circuit boards 1, 2 with an overlap, the first lands 11, 11A1 through 11A2, and 11B1 through 11B3 and the second lands 21, 21A, which are provided on each circuit board, are soldered face-to-face. Here, in the first lands 11, 11A1 through 11A2, and 11B1 through 11B3 are formed the non-facing regions R1 through R4, R1A1 through R4A1, R1A2 through R4A2, R1B1 through R2B1, R1B2 through R2B2, R3B, R4B, and the opening by the through hole H1, which have spreads from the regions facing to the second lands 21, 21A and do not face to the second lands 21, 21A. Thus, in the solder bonding, the solder fillets are formed in these non-facing regions, and this serves to enhance the strength of solder bonding between the first and second lands.

In addition, at least a part of the non-facing regions is not overlapped by the second circuit board 2; therefore in the solder bonding, the solder fillets can easily be viewed. In this manner, the state of the solder bonding can easily be confirmed.

In the modified example (FIG. 7) of the first embodiment, the first lands 11A1, 11A2 have a trapezoid shape, and in the first circuit board 1, the first lands 11A1, 11A2 are laid out in a manner that the upper base and the lower base are alternately inverted at each of the lands placed adjacently. Therefore, the pitch of disposition PA can be narrowed in comparison to the pitch of disposition P in case of adjacently disposing the first lands 11 in a square shape

In the second embodiment (FIG. 8), the non-facing regions are not provided to the sides of the adjacent lands of the first lands 11B1 through 11B3 disposed in one row, but are provided to the peripheries of the first land row, whereby the first land row in total secures the strength of solder bonding. Thus, the pitch of disposition PB of the first lands 11B1 through 11B3 can be reduced further.

As described in the third embodiment, using the second land 21A with the through hole H1 pierced will make it possible to easily confirm the state of the solder bonding, and to strengthen the solder bonding in every direction since the solder bonding is made on the side wall of the through hole H1.

The present invention is not restricted to the foregoing embodiments, and naturally various modifications and improvements are possible without departing from the purpose of the invention.

The above embodiments have been described on the assumption that the second circuit board 2 is an FPC board; however, the invention is not restricted to this, and the second circuit board 2 may be replaced by a similar board to the first circuit board 1. Further, both the first and second circuit boards 1, 2 may be replaced by a printed wiring board of an FPC board or the like.

The shapes of the lands are assumed to be polygons such as a square (first lands 11, second lands 21), trapezoid (first lands 11A1, 11A2), and rectangle (first land 11B1 through 11B3); however, naturally the same function and effect can be achieved by other shapes. Further, in regard to the through hole H1 provided to the second land 21A, it is natural that various modifications as to the size and the number thereof are possible, within the scope that the basic function of the second land of soldering the first and second circuit boards 1, 2 is not lost.

When parts of the second lands face to the first lands, in the second lands is formed the non-facing region which has spreads from the region facing to the first lands and does not face to the first lands. In the solder bonding, in the non-facing region is formed the solder fillet. In combination with the solder fillet in the non-facing region of the first lands, in the solder bonding, the solder fillets are formed in these non-facing regions, and this serves to further enhance the strength of solder bonding between the first and second lands

A part of the first land may completely overlap the second land. When a part of the first land completely overlaps the second land, the non-facing region may be formed in the entirety of a periphery of the first land. When the solder fillet is formed in such a non-facing region, the strength of solder bonding can be enhanced in every direction.

The through hole may be provided to the first circuit board instead of the second circuit board. In addition, the through hole may be provided to both of the first circuit board and the second circuit board. When the through hole is provided to the first circuit board, the solder fillet can easily be viewed from the first circuit board overlapped with the second circuit board. When the through hole is provided to the second circuit board, the solder fillet can easily be viewed from the second circuit board overlapped with the first circuit board. When the through holes are provided to the first circuit board and the second circuit board, the solder fillet can easily be viewed from either side of the first circuit board and the second circuit board. In this case, in the state where the first land faces to the second land, the through holes are pierced through the first land and the second land desirably in positions offset from each other.

Therefore, the present examples and embodiments are to be considered as illustrative and not restrictive, and the invention is not to be limited to the details given herein but may be modified within the scope of the appended claims.

What is claimed is:

1. A composite circuit board comprising:
a first circuit board having a first land; and
a second circuit board having a second land at least a part of which is soldered to a part of the first land face-to-face,
wherein the first land has a region overlapped by the second circuit board, and the region has a non-facing region which does not face to the second land.

2. The composite circuit board according to claim 1, wherein the non-facing region is disposed on ends in at least two directions of the first land.

3. The composite circuit board according to claim 2, wherein a part of the first land completely overlaps the second land.

4. The composite circuit board according to claim 2, wherein the first land is a polygon and wherein the non-facing region is disposed on sides in at least two directions of the polygon.

5. The composite circuit board according to claim 4, wherein the polygon is a square.

6. The composite circuit board according to claim 4, wherein the polygon is a trapezoid.

7. The composite circuit board according to claim 2, wherein the first land is a polygon, wherein the number of first lands is plural and the plural first lands are adjacently disposed, and wherein the non-facing region exists on the ends of the first lands which are disposed on sides in at least two directions of a periphery of a region in which the plural first lands are disposed.

8. The composite circuit board according to claim 7, wherein the polygon is a rectangle.

9. The composite circuit board according to claim 1, wherein at least one of the first circuit board and the second circuit board has a hole formed therethrough, wherein the hole has a side wall which is formed continuously from the land of the one circuit board, and wherein at least a part of the hole faces to the land of the other circuit board.
